(19) United States
(12) Patent Application Publication
(10) Pub. No.: US 2010/0102972 A1
(43) Pub. Date: Apr. 29, 2010

(54) DRIVER INATTENTION DETECTION SYSTEM AND METHODOLOGY

(75) Inventors: Richard Middlekauff, Jacksonville, FL (US); Percy F. Shadwell, Jacksonville, FL (US); Peter Schonning, Jacksonville, FL (US); Henrik Stahre, Jacksonville, FL (US)

Correspondence Address: MARK YOUNG, P.A., 12086 FORT CAROLINE ROAD, UNIT 202, JACKSONVILLE, FL, 32225, US

(73) Assignee: TRANSPORTATION SAFETY PRODUCTS, INC., Jacksonville, FL (US)

(21) Appl. No.: 12/260,286

(22) Filed: Oct. 29, 2008

(51) Int. Cl. G08B 23/00

(52) U.S. Cl. 340/576

(57) ABSTRACT

A driver inattention detection system includes a rotary encoder (e.g., an optical rotary encoder) operably associated with a steering column of a vehicle and configured to produce steering signals representing the magnitude and direction of rotation of the steering column. A drive wheel concentrically coupled to the rotatable shaft of the encoder has a knurled peripheral edge that frictionally engages the steering column or a frictional band surrounding a portion of the steering column. A control module determines a steering count and if a driver inattention condition exists. The driver inattention condition exists if the vehicle is traveling above a minimum speed, and there has been no recent braking activity, and the active steering count is below a determined minimum threshold steering count. Separate first and second alarm modules operably coupled to the control module may be independently activated in a progressive manner. All sensed conditions and responses may be logged. The encoder may be calibrated to accurately indicate steering action. The system may be calibrated to determine an appropriate minimum steering count for a determined time period for the particular vehicle. Cruise control is disabled if a driver inattention condition persists after alarm activation.

### FIELD OF THE INVENTION

This invention generally relates to a driver inattention detection system, and, more particularly, to a system and method that monitors a driver's use of a steering wheel to detect the possibility of fatigue and issue progressive warnings and an operational response.

### BACKGROUND

As the number of traffic accidents due to diminished driver vigilance has increased, products to detect inattention have emerged. Automated inattention detection devices show much promise in combating related accidents. Inattention, which may be due to fatigue, distraction, disengagement or intoxication, may be detected by monitoring the driver and/or vehicle. Detection products include readiness-to-perform and fitness-for-duty technologies, which attempt to test and assess the vigilance capacity of an operator before commencing a trip. In-vehicle operator status monitoring technologies monitor physiological conditions, such as pupil state, grip, pulse and/or head position, and compare the monitored attributes with those indicative of fatigue. Vehicle-based performance technologies detect the behavior of a driver by monitoring the transportation hardware systems under the driver's control, such as driver's steering wheel movements, acceleration, braking, and gear changing.

Of the various inattention and fatigue detection systems, vehicle-based performance technologies offer several practical advantages. Among the advantages are convenience, seamless integration and continuous monitoring. In contrast, readiness-to-perform and fitness-for-duty technologies disadvantageously consume appreciable time, are perceived by some drivers as an inconvenience and an invasion of privacy, and can be manipulated by user input. Likewise, in-vehicle monitors that require connections to a driver's body are inconvenient, intrusive, uncomfortable and a hassle to install and remove.

One example of a vehicle-based performance technology is a steering-based system that monitors for micro-steering, a series of small steering movements by an alert driver to correct the course of a vehicle. If a driver ceases micro-steering, the vehicle begins to drift or change lanes. When this occurs the driver is assumed to be fatigued and inattentive. While steering-based systems provide an excellent means for monitoring driver fatigue, heretofore, systems based upon such technologies have lacked reliability, ease of installation, adaptability to a wide range of vehicles, and driver acceptance.

Illustratively, U.S. Pat. No. 7,138,923 to Ferrone, et al., describes a system that monitors the steering input behavior of a driver during a specified period of time. If the number of steering inputs is below an expected predetermined threshold, the system activates an alarm, such as an audible alarm and/or light in the cab, waking and/or stimulating the driver. The system may also deactivate cruise control and/or activate various other truck systems/components connected with the system to further aid in the control of the truck and to alert nearby motorists.

Similarly, U.S. Pat. No. 6,198,397 to Angert, et al., also describes a steering wheel movement sensing apparatus comprising a magnetic sensing means for detecting variations in magnetic flux. A magnetic strip having varying magnetic flux lines is attached to the steering shaft and in close proximity to a magnetic sensing means so that magnetic flux emanating from the magnetic strip impinges upon the magnetic sensing means. The magnetic strip moves with the magnetic sensing means when the steering shaft is rotated. A microcontroller monitors oscillator signals from a circuit coupled to the sensor. The period of the oscillator signal is averaged over a fixed period of time to determine a current frequency. Then, the period of the oscillator signal is averaged again over a second interval of time (for example 25-200 milliseconds), and compared with the previous average to ascertain whether sufficient deviation is detected. If the frequency deviation fails to exceed a predetermined deviation quantity over a three to five second period, then the microcontroller produces an alarm signal supplied to a speaker to produce an audible alarm and a cruise control disable signal to deactivate the cruise control device and begin deceleration.

While such prior art systems are useful for their intended purposes, they suffer certain shortcomings. For example, Ferrone and Angert require precise positioning of a magnetic sensor in relation to a magnetic field source. Such precision can be difficult, if not impossible, for a mechanic to achieve in installing the system on a vehicle. Additionally, movement and vibration of the steering column relative to the sensor may generate erroneous micro-steering signals. Furthermore, electromagnetic interference from nearby electronic components may cause the sensors to generate spurious signals.

Another shortcoming of the prior art is lack of a reliable baseline. The use of a predetermined count, as in Ferrone, ignores a driver's actual performance, road conditions and variations in suspension and steering from one vehicle to another. Likewise, examining variations in average steering counts from one time interval to the next succeeding time interval, as in Angert, makes it extremely difficult to detect a gradual decline in vigilance and responsiveness. Comparisons between such intervals also disregard road conditions such as smooth versus bumpy and a turn versus a straightaway, all of which can significantly impact results.

Yet another shortcoming of the prior art is the limited range of responses. Prior art systems, like Ferrone and Angert, sound an audible alarm when any fatigue event is perceived. Where such systems err on the side of caution, the result is many false alarms, with the same disruptive audible signal used to wake a fatigued driver. Furthermore, Ferrone deactivate cruise control, if driver fatigue is detected. The prior art does not provide progressive responses, starting with a subtle indicator and escalating the output if a driver does not promptly respond. The unfortunate result is frequent interference with driver performance and tranquility when a decrease in steering adjustments may simply be due to the direction of travel and road conditions, rather than driver fatigue.

What is needed is an easy-to-install and reliable system and method to detect the possibility of inattention by monitoring a driver's use of a steering wheel and to issue a progressive warning and operational response. The invention is directed to overcoming one or more of the problems and solving one or more of the needs as set forth above.

### SUMMARY OF THE INVENTION

To solve one or more of the problems set forth above, an exemplary driver inattention detection system according to principles of the invention includes a rotary encoder (e.g., an optical rotary encoder) operably associated with a steering column of a vehicle. The rotary encoder is configured to produce steering signals representing the magnitude and direction of rotation of the steering column. A control module is operably coupled to the rotary encoder and configured to receive the steering signals, determine a steering count and determine if a driver inattention condition exists. The driver inattention condition includes a steering count below a determined minimum threshold steering count.

To enable progressive warning and an operational response in the event inattention is detected, a first alarm module operably is coupled to the control module. The first alarm module is configured to generate an alarm output perceptible to the driver upon receiving an alarm activation signal. The control module is configured to generate and communicate a first alarm activation signal to the first alarm module if the control module determines that a driver inattention condition exists. In one embodiment, the first alarm module is a unit that is about the size of a vehicle rocker switch and configured to plug neatly into a socket in a dashboard. Alternative embodiments include units configured to mount below or atop of the dashboard, as well as on the windshield, headliner, rear-view mirror, or a head-up display. The module may include a light emitting element (e.g., an LED) and a sound emitting element (e.g., a buzzer or speaker).

A second alarm module separate from the first alarm module may also be provided. In such an embodiment, the control module is configured to generate and communicate a second alarm activation signal to the second alarm module if the control module determines that a driver inattention condition persists for a determined amount of time after a first alarm activation signal is generated and communicated to the first alarm module. The second alarm module may be contained in a tamper resistant enclosure that also contains the control module.

An exemplary rotary encoder includes a rotatable drive shaft and a drive wheel concentrically coupled to the rotatable shaft. The drive wheel has a peripheral edge that frictionally engages the steering column. Rotation of the steering column causes the frictionally engaged drive wheel to rotate, which causes the rotatable drive shaft to rotate. Advantageously, the drive wheel may frictionally engage a steering column of any size.

To enhance frictional engagement between the steering column and drive wheel, a frictional band (e.g., a resilient elastomeric band such as a rubber band) may surround a portion of the steering column. The frictional band may be adhesively bonded to the steering column. The peripheral edge of the drive wheel frictionally engages the frictional band, which transmits torque from the steering column to the drive wheel.

In an exemplary embodiment, a mounting bracket is pivotally coupled to the rotary encoder and configured for attachment to a support structure adjacent to the steering column. Attachment may be achieved using any permanent or releasable attachment means, including, but not limited to, double-sided tape.

To maintain good traction between the steering column and drive wheel, in an exemplary embodiment a biasing means urges the rotary encoder with the drive wheel towards the steering column. Additionally, the peripheral edge of the drive wheel may be frictionally enhanced (e.g., knurled).

Means for determining speed of the vehicle (e.g., a speed sensor) may be communicatively coupled to the control module. By monitoring vehicle speed, the system may avoid alarms and disablement of cruise control when the vehicle is traveling at a low speed, i.e., a speed below a minimum threshold speed for alarm activation. Also, speed data may be logged.

Means for determining brake activation (e.g., a connection to a brake lighting circuit or to a brake switch) may be communicatively coupled to the control module. By monitoring braking, the system may avoid alarms and disablement of cruise control when recent brake activity (i.e., evidence of driver attentiveness) is detected. Also, brake activity may be logged.

An exemplary driver inattention detection system according to principles of the invention may be calibrated. Calibration may ensure that steering signals are accurately processed. Calibration may also set a minimum threshold for steering signal activity, below which driver inattention is assumed. Calibration may also ensure that the speed sensor signals are accurately processed. The system may be calibrated to work with a wide range of vehicles and drivers. Steering sensor calibration and main system calibration may happen simultaneously during a calibration run.

To initiate and control calibration, a calibration mode selection switch may be communicatively coupled to the control module. The control module is configured to operate in calibration mode when the calibration mode selection switch is activated. An adjustable low pass filter configured to receive steering signals allows modification (e.g., filtering) of the steering signals so that the steering signals received by the control module through the filter accurately represent the magnitude and direction of rotation of the steering column. Calibration mode adjusts the low pass filter until a high frequency wave count does not exceed a threshold and the steering signals received by the control module through the filter represent the magnitude and direction of rotation of the steering column.

An exemplary method for driver inattention detection according to principles of the invention includes using an adjustable low pass filter to calibrate a rotary encoder operably associated with a steering column of a vehicle. The calibrated rotary encoder produces steering signals representing the magnitude and direction of rotation of the steering column. A minimum threshold steering count in a determined time period is determined during a calibration run. Then, while the vehicle is driven after calibration has been completed, an active steering count representing steering system activity during driving is determined.

A driver inattention condition may be determined to exist if an active steering count is below the determined minimum threshold steering count. In such case, a first alarm perceptible to a driver may be activated upon determining that a driver inattention condition exists.

A driver inattention condition may be determined to exist if an active steering count (the steering count determined while driving after calibration has been completed) is below the determined minimum threshold steering count and there has not been recent braking activity over a determined preceding period of time, as may be determined from a brake signal or hold off timer.

A driver inattention condition may be determined to exist if an active steering count (the steering count determined while driving after calibration has been completed) is below the determined minimum threshold steering count and the vehicle is traveling at a speed that is equal to or greater than a minimum threshold speed determined during a preceding period of time.

When a driver inattention condition is determined to persist after the first alarm module has been activated, then a second alarm perceptible to the driver may be activated. When a driver inattention condition is determined to persist after the second alarm module has been activated, then a cruise control module (if any is provided in the vehicle) is deactivated (if it has been activated when a driver inattention condition is determined).

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of an exemplary driver fatigue detection system in accordance with principles of the invention; and

FIG. 2 is a high level block diagram of an exemplary control module for a driver fatigue detection system in accordance with principles of the invention; and

FIG. 3 is a high level block diagram of an exemplary dash module for a driver fatigue detection system in accordance with principles of the invention; and

FIG. 4 is a high level flow chart of an exemplary system calibration methodology for a driver fatigue detection system in accordance with principles of the invention; and

FIG. 5 is a high level flow chart of an exemplary steering sensor calibration methodology for a driver fatigue detection system in accordance with principles of the invention; and

FIG. 6 is a high level flow chart of an exemplary low alertness alarm methodology for a driver fatigue detection system in accordance with principles of the invention; and

FIG. 7 is a diagram that conceptually illustrates an exploded view of an exemplary steering sensor assembly for a driver fatigue detection system in accordance with principles of the invention; and

FIG. 8 is a diagram that conceptually illustrates an exemplary steering sensor assembly and a steering column for a driver fatigue detection system in accordance with principles of the invention; and

FIG. 8A is a diagram that conceptually illustrates an exemplary steering sensor assembly and a steering column for a driver fatigue detection system in accordance with principles of the invention; and

FIG. 9 is a diagram that conceptually illustrates an exemplary steering sensor assembly for a driver fatigue detection system in relation to a disassembled steering shroud in accordance with principles of the invention; and

FIG. 10 is a diagram that conceptually illustrates a dash module for a driver fatigue detection system in accordance with principles of the invention; and

FIG. 11 is a diagram that conceptually illustrates internal components of a dash module for a driver fatigue detection system in accordance with principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the order of shapes, steps or types of components, shapes, relative sizes, ornamental aspects or proportions shown in the figures.

### DETAILED DESCRIPTION

Referring to the Figures, in which like parts are indicated with the same reference numerals, various aspects of a driver fatigue detection system and methodology in accordance with principles of the invention are shown. The system and methodology detect inattention by monitoring the driver's use of the steering wheel. A unique sensing device, which is biased against the column of a steering system, provides information on the angular displacement and/or direction of steering wheel movement. The sensing device may be calibrated to work with a wide range of steering systems. A speed sensor monitors vehicle speed. Brake signals are also monitored. A microcontroller analyzes signals representing steering wheel movements and assesses if it is likely that the driver is becoming less attentive based upon a calibrated baseline. The assessment entails determining if the vehicle is traveling at a speed above a threshold speed, and if the driver has not recently applied the brakes, and then comparing steering counts with a calibrated steering count threshold, below which it is assumed that the driver is inattentive. If an inattention condition is determined, the system may generate a variety (e.g., progression) of audible and visual signals to get a driver's attention, and eventually disengage the cruise control if it is active. The alarms may be subtle at first, with intensity increasing if driver inattention persists.

In order to avoid unnecessary alarms, the exemplary system monitors the state of the ignition key, speed of the vehicle, and the use of the brake pedal. The system may be programmed to not generate alarms when the vehicle is travelling under a selected speed. Also, it can be set to not generate alarms during and within certain periods of time after the brake pedal having been engaged, as the use of the brake could indicate that the driver is in control and perhaps in the midst of a maneuver where steering may be abnormal.

The system is configured to calibrate itself to the individual vehicle on which it has been installed. The installer can initiate a calibration mode and after a short calibration drive, the controller stores in non-volatile memory, important parameters relevant to that individual vehicle's operation (e.g. speed sensor data calibration based on varying wheel size and differential ratios, baseline steering wheel movement, etc.). The system allows easy recalibration if the vehicle changes over time or is modified, or if the device is moved to a new vehicle. Steering sensor calibration and main system calibration may happen simultaneously during a calibration run.

One embodiment of the invention includes the ability to log certain events in non-volatile memory, indexed by date and time. These entries may include steering alarms, speed of the vehicle, miles driven, start and stop times, and other data as additional inputs are supplied to the control module. This embodiment includes a battery backed-up real-time clock to ensure accurate time stamps of log entries.

Another embodiment includes a serial data port through which the user may set certain operating parameters, such as activation speed, steering gate period, braking hold off time, and reset and retrieve the log. Any of a variety of serial interfaces, wired or wireless, may be used, including but not limited to RS-232, USB, IrDA, Bluetooth, Zigbee, WiFi, and other protocols.

Another embodiment of the invention provides an escalation sequence, where the longer the steering signal shows inattentiveness, the more prominent the alarm becomes. In this implementation, the volume and characteristics of the two audible output devices, internal and dash mounted, can be independently controlled.

Another embodiment generates voice messages for the driver for information or alarms. Audible voice messages may communicate a generic warning or a warning tailored for a specific perceived event.

Another embodiment provides a programmable delay before the cruise control is disengaged, so that a very brief loss of steering signal would not automatically turn off that function, even though the alarm may briefly sound.

Another embodiment includes a CAN protocol interface for the addition of other input and output devices to expand the functionality of the system. This protocol may also be used to retrieve data from the vehicle control computers to aid in the driving analysis or to trigger other useful log entries.

Another embodiment of the invention includes a graduated speed gate. This refers to the time for which pulses from the speed sensor are accumulated in order to measure the speed of the vehicle. At higher speeds, where pulses are accumulated very quickly, a short speed gate time suffices. As the vehicle slows, fewer and fewer pulses will be accumulated during that short time, thus reducing precision of measurement. An embodiment of the invention increases the gate time as the speed of the vehicle decreases in order to keep speed measurement precise.

Another embodiment of the invention includes curve detection. Curve detection is a method for analyzing data from speed, steering, and brake sensors to determine when the vehicle is rounding a long curve that might cause a false alarm from the attentiveness logic. A curve may also be detected using a global positioning system (GPS). In a curve maneuver, the driver maintains the steering wheel in some angular position for an extended period of time without returning it to home. By way of example, if a steering wheel is held in an angular position (i.e., turning position), resisting the tendency of the steering wheel to return to a home position, for an extended period of time, then vehicle may be traveling along a curve. In such a case, steering corrections normally expected on a straight road may not be expected throughout the curve. GPS data, if available, may verify the curve condition.

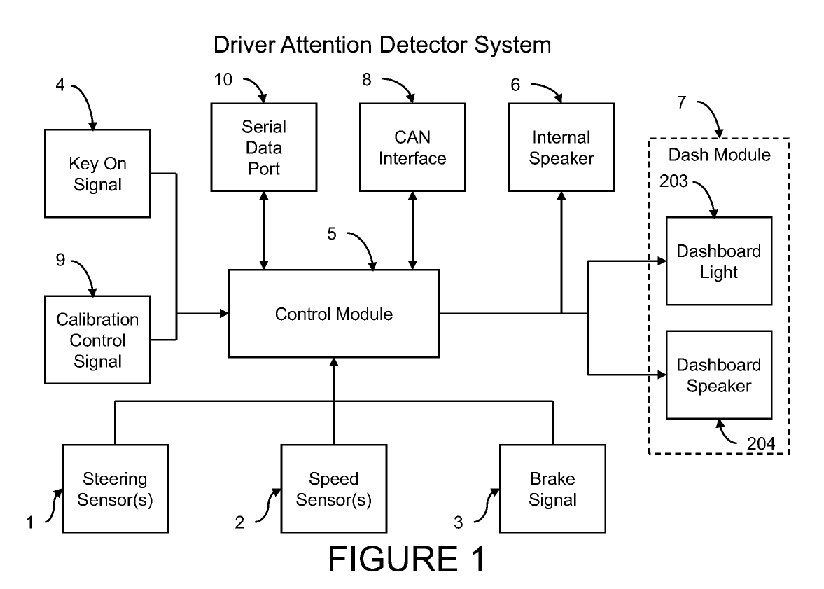

With reference to FIG. 1, an exemplary driver fatigue detection system detects when a driver of a motor vehicle is less attentive and alerts the driver to this state is conceptually illustrated. The system includes a device to monitor the speed of the vehicle, the use of the brake pedal, steering wheel operation (angular displacement and direction over time), a central processor to analyze input signals, and a dashboard audible output device and visual indicator. The system comprises four component modules, namely a steering sensor 1, a speed sensor 2, a control module 5, and a dashboard module 7. The system is connected to the vehicle wiring through a ground connection, a continuous +12 volt connection, a key switched +12 volt connection, and a connection to the brake light circuit (signal may be of either polarity). In the case that the cruise control override is added, a relay is used to signal a brake depression to the cruise interlock system.

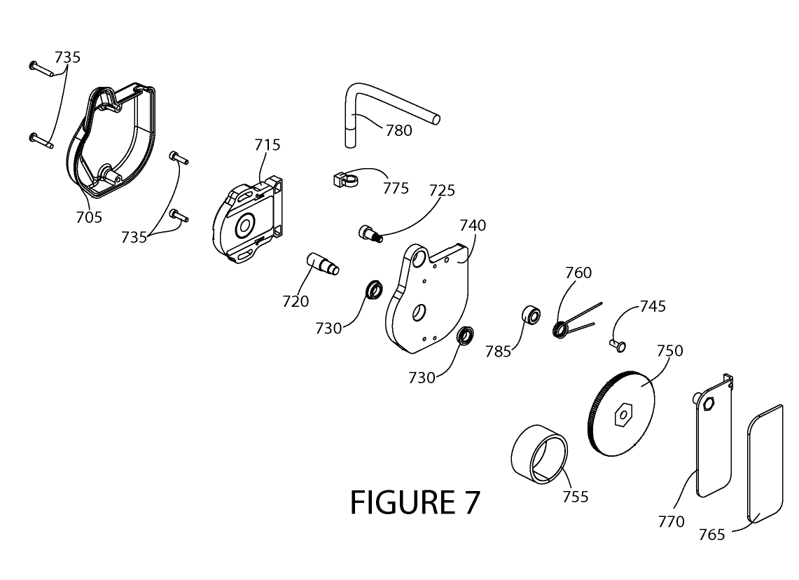

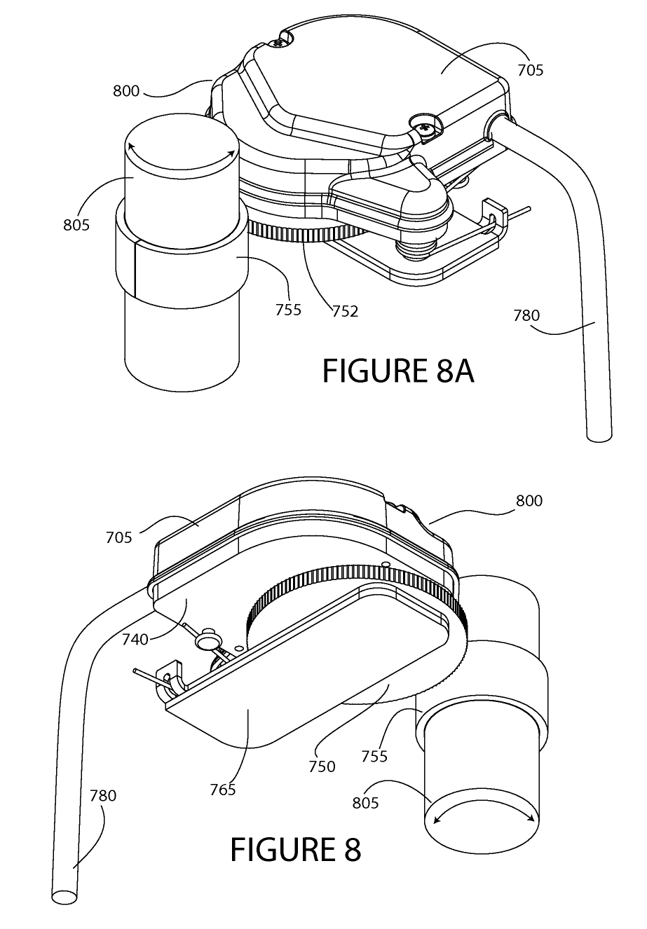

The steering sensor 1 is designed to measure the steering wheel direction and magnitude of rotation while the driver is driving. The signal from this sensor is delivered to the control module 5 means through a multi-conductor cable. FIGS. 7 and 8 conceptually illustrate principal components of an exemplary steering sensor 1 in accordance with principles of the invention. The sensing element is a motor shaft optical encoder 715 with a quadrature output comprised of two signals 90 degrees out of phase, referred to herein as phases A and B. Using a state machine, e.g., software configured to model behavior composed of a finite number of states, transitions between those states, and actions, the direction and amplitude of angular displacement are recovered. In alternative embodiments, the state machine may comprise a programmable logic device, a programmable logic controller, logic gates and flip flops or relays, or the like.

With reference to FIGS. 7, 8 and 8A, the sensor comprises an encoder frame 740. The encoder frame 740 has a hole with recesses on the top to accommodate the flange of the bearing 730. A shaft 720 provides support for a perforated optical wheel inside of optical encoder 715. An exemplary optical encoder 715 is an RCML15 low profile optical encoder available from Renco Encoders, Inc., of Goleta, Calif., www.renco.com. The RCML15 encoder provides brushless motor commutation pulses and incremental position feedback. A rotatable wheel 750 couples the shaft 720 of the encoder frame 740 to a steering wheel shaft (i.e., a steering column). The periphery 752 of the exemplary wheel 750 is frictionally enhanced, e.g., knurled or otherwise textured or coated to improve traction. To improve mechanical friction, which operably couples the wheel 750 to the steering wheel shaft, the area on the steering shaft where the wheel 750 will rub is wrapped with a friction band 755. The friction band 755 may be a rubber band held in place with an adhesive, a double-sided adhesive tape or other bonding element. A dust cover 705 protects the sensing element's contents and also relieves strain for the encoder cable 780 with the aid of a tie wrap 775 located inside of the cover. This dust cover 705 is designed to fit very snuggly, thus dramatically improving resistance to contaminants and moisture. The encoder frame 740 is mounted to an encoder mount plate 770 with a shoulder screw 725 and sleeve bearing 785 to permit the sensor assembly to swing freely around the shoulder screw 725 independently of the encoder mounting plate 770. A spring 760 is provided in operative relation to the shoulder screw 725 to urge the wheel 750 against the friction band 755 (e.g., rubber tape) on the steering wheel shaft. Double sided adhesive tape 765 (or other means for attachment) may be used to attach the encoder mounting plate 770 to a nearby surface that will permit the wheel 750 to rotate freely as it is driven by the vehicle steering wheel shaft movement. Screws 735, a rivet 745 and/or other attachments may be used to complete assembly of the sensing element.

It is understood that varying the resolving ability of the optical encoder 715 and/or the diameter of the wheel 750 will alter the sensor's angular resolution and its susceptibility to vibrational noise in the steering system. Thus, the subject invention provides means (i.e., a replaceable wheel 750) for easily adjusting resolution of the sensing element.

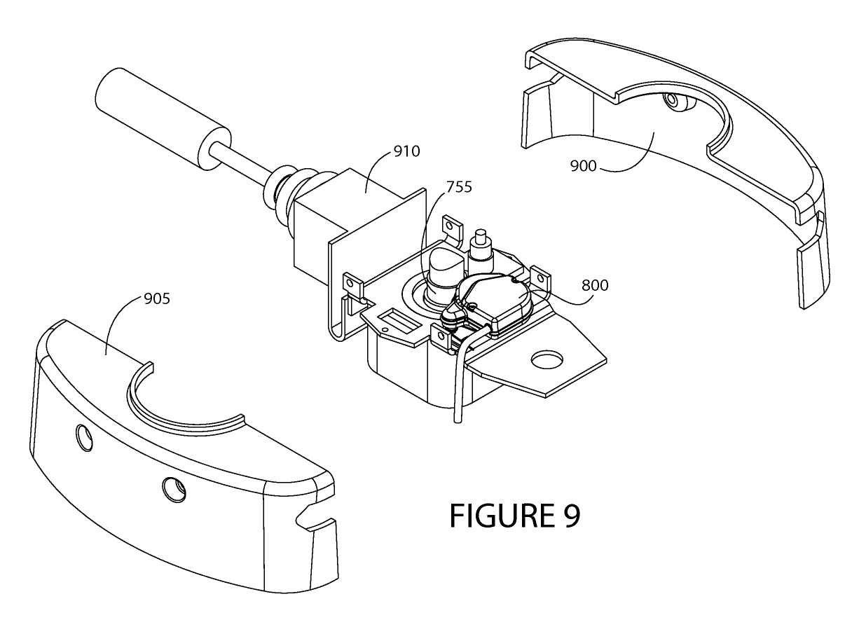

An exemplary sensor assembly 800 is illustrated in FIGS. 8 and 8A. Rotation of the steering wheel shaft 805 causes the friction band 755 to transmit rotational force to the wheel 750. The periphery 752 of the exemplary wheel 750 is knurled or otherwise textured to improve traction. Rotation of the wheel 750 causes the encoder shaft 720 to rotate. Rotation of the encoder shaft 720 affects the optical encoder's 715 quadrature output, indicating the direction, rate and magnitude of rotation. The sensor assembly 800 may be installed behind a steering column shroud 900, 905 adjacent to directional controls 910 as shown in FIG. 9, or at any other location in operable relation to a rotatable shaft of a steering column. The optical encoder 715 is not dependent upon variations of a sensed magnetic field. The spring biased wheel 750 maintains contact with the band 755 on the steering shaft 805 at all times during operation, regardless of vibrations.

Referring again to FIG. 1, the speed sensor 2 may, for example, be a variable reluctance type speed sensor used in many motor vehicles today. In many modern speedometers, a rotation sensor, usually mounted on the rear of a transmission, delivers a series of electronic pulses whose frequency corresponds to the rotational speed of the driveshaft. The speed sensor may employ a toothed metal disk, that is attached to the vehicle's drive shaft, positioned in close proximity to a coil and a magnetic field or a permanent magnet such that the coil generates a small current as ferrous objects pass by. As the disk turns, the teeth/ferrous objects pass near the magnetic field source and the magnetic field senor, each time producing a pulse in the sensor as they affect the strength of the magnetic field on the coil. Processing circuitry converts the pulses (i.e., current signals) to a speed and displays this speed on an electronically-controlled, analog-style needle or a digital display, the latter of which is more prevalent today. The processing circuitry may comprise an analog circuit configured to convert the current signals to logic level signals. The first derivative of this signal with respect to time reveals speed. Using two such sensors allows measurement of distance and direction of vehicle movement. Pulse counts may also be used to increment the odometer.

In addition to or in lieu of such conventional speed sensors, a global positioning system (GPS) device capable of estimating speed based on change in position between measurements may be utilized. As the GPS is an independent system, its speed calculations are not subject to the same sources of error as a vehicle's speedometer. Instead, the GPS's positional accuracy, and therefore the accuracy of its calculated speed, is dependent on the satellite signal quality at the time. GPS speed calculations tend to be more accurate at higher speeds, when the ratio of positional error to positional change is lower. The GPS system may also use a moving average calculation to reduce error. Furthermore, the GPS may readily determine distance and direction of travel.

The brake signal 3 may comprise any connection to a brake light system or a brake switch, indicating that the brakes have been actuated to achieve a brake on state. A system according to principles of the invention may calibrate itself using the polarity of the signal for a brake on state. The calibration methodology is described below. The control module 5 includes input signal conditioning to prevent damage from inputs through the entire range of possible voltages in the vehicle. Steering sensor calibration and main system calibration may happen simultaneously during a calibration run.

A key on signal 4 may be a connection to any point in the vehicle wiring that is energized only when the ignition key is in the run position. The ignition wiring system typically includes a switch linked to sensors, anti-theft devices, interlocks, and peripheral devices (e.g., radios, cigarette lighters, etc).

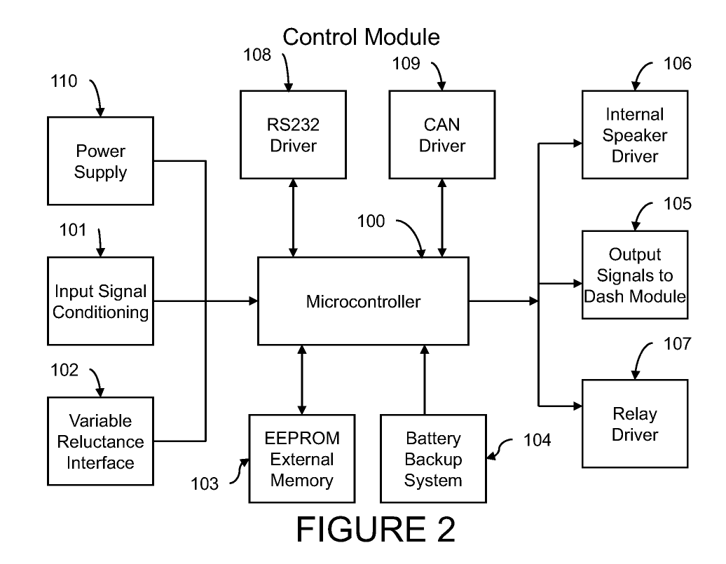

In an exemplary implementation, the control module 5 comprises a container (e.g., a metal box) holding a circuit board capable of receiving and generating the signals described. With reference to FIG. 2, a power supply 110 provides low voltage electric power for the digital circuitry. A microcontroller 100 provides control intelligence and the computational functions required to make the system work. In a preferred embodiment, the microcontroller includes internal non-volatile memory in which to store configuration and calibration data. The microcontroller also provides a low power consumption real-time clock function. Signal conditioning means 101 converts 12 volt signals into logic levels and also prevents damage from accidental cross connections. The signal conditioning element 101 may amplify, attenuate, filter, isolate, sample and multiplex signals from the sensors and encoder for proper and accurate processing by the microcontroller.

The variable reluctance (VR) interface 102 is a circuit (e.g., integrated circuit) designed to convert the signals from VR sensors (e.g., speed sensors) into logic level signals. As discussed above, a VR sensor consists of a coil of wire wrapped around a magnet. As gear teeth (or other target features) pass by the face of the magnet, they cause the amount of magnetic flux passing through the magnet and consequently the coil to vary. In a VR sensor, the resulting analog signal must be filtered and thresholded to yield a useful pulse output. When a target feature (such as a gear tooth) is moved close to the sensor, the flux is at a maximum. When the target is further away, the flux drops off. The moving target results in a time-varying flux that induces a proportional voltage in the coil. The VR interface receives the analog signal and produces a digital waveform that can be more readily counted and timed.

Nonvolatile memory, such as EEPROM external memory 103, is provided to store a log of alarm events for later recall. Alternative forms of nonvolatile storage means, such as Flash Memory, Ferroelectric RAM (FeRAM) and/or Magnetoresistive Random Access Memory (MRAM), may be used in addition to or in lieu of the EEPROM.

A battery backup system 104 includes charging circuitry and is configured to automatically provide power to the microcontroller 100 when the vehicle power supply is disconnected. When the vehicle power supply is disconnected, the device will switch to a low power mode and use only enough power to keep track of the time and date. The charging circuit may be any circuit configured to connect a DC power source (e.g., vehicle power) to the battery being charged. By way of example and not limitation, the circuit may be a trickle charger that charges the battery slowly, at about the self-discharge rate; a timer charger that terminates charging after a pre-determined time to avoid overcharging; an intelligent charger that monitors the battery's voltage, temperature and/or time under charge to determine the optimum charge current terminate charging when a combination of the voltage, temperature and/or time indicates that the battery is fully charged.

The RS232 driver 108 is an integrated circuit that converts the logic level serial data from the microcontroller 100 means into acceptable RS232 levels. The driver enables serial binary data communication through the serial data port 10. The data is sent as a time-series of bits at voltage levels that correspond to logical one and logical zero levels. The port 10 may be used for entering user parameter settings and for log down load. Other data communication drivers, such as USB, may be provided in addition to or in lieu of the RS232 driver.

As shown in FIG. 1, a CAN (Controller-area network) interface 8 is intended to serve as an expansion bus for future additions to the system and as a port to exchange information with other CAN-enabled devices, such as the engine control unit or controllers for the transmission, airbags, antilock braking, cruise control, audio systems. Operably coupled to the CAN interface 8, as illustrated in FIG. 2, a CAN driver 109 integrated circuit converts the logic level serial data from the microcontroller 100 into acceptable CAN levels for communication in accordance with the CAN computer network protocol and bus standard.

An internal speaker 6 is connected to the control module 5. The internal speaker 6 is a noise making device mounted inside a housing that contains the control module 5. Having this audible output device inside a housing, such as a sealed metal box, makes the system more tamper resistant. The internal speaker 6 also provides a redundant audible output device, as a backup. Because separate sound emitting devices are provided and controlled independently, the system may activate them in succession to provide an audible alarm with progressively increasing amplitude. In addition, the control module 5 may digitally modulate the current to each or both of these noise making devices to change the amplitude or other character of sound.

An internal speaker driver 106 is controlled by logic level signals from the microcontroller 100. The speaker driver is configured to turn the internal control module speaker (e.g., loudspeaker or buzzer) 6 on and off, controlling the emission of audible output from the speaker 6.

A relay driver 107 provides up to 1.5 amps for relay activation to be used for the cruise control de-activation and/or an auxiliary audible output device. The relay driver 107 may be any driver circuit suitable for energizing a given relay, including, but not limited to, a transistor driven relay driver configured to reduce the relay sensitivity, a delayed turn-on relay driver that produces a time delay, or an automatic turn-off relay configured to turn a relay on when power is applied to the driver and automatically turn off the relay after a determined delay.

The output signals to dash module 105 comprise a set of protected (i.e., from erroneous voltage applications) logic level output signals that control devices (e.g., audible and visual output devices) in the dash module 7. By way of example and not limitation, two signal lines may be used to control a bi-color LED 203 in the dash module 7, and one signal line may control a dashboard loudspeaker 204.

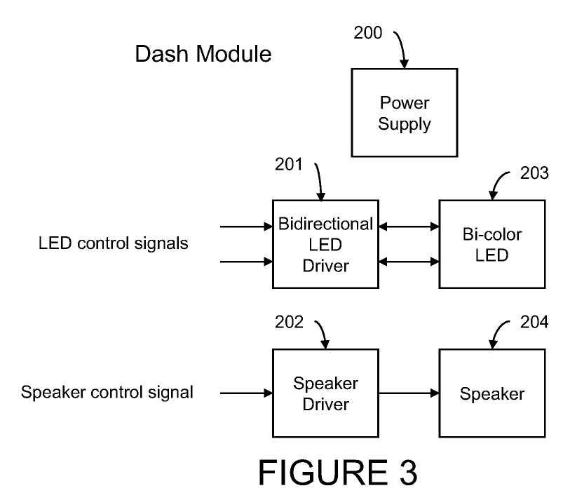

The dash module 7 is an indicator mounted in close proximity to the vehicle driver. This unit contains a power supply 200 means for low voltage components, and a bidirectional LED driver 201 that powers a bi-color LED 203 that indicates system status to the driver, as shown in FIG. 3. In an exemplary embodiment, off indicates test mode where steering and speed sensors may be tested, solid yellow (which is achieved by constantly switching the direction of current flow through the LED thereby blending red and green into a yellow color) indicates that the unit is waiting to begin the calibration run, flashing yellow indicates that the calibration run is underway, solid red indicates that the vehicle is moving at less than the minimum operating speed, and solid green indicates that the system is operating and active. The dash module also contains a speaker driver 202 that powers a dashboard loudspeaker 204. In addition to power, three logic level signals are received by this module from the control module 5. Two control the LED operation and one the speaker.

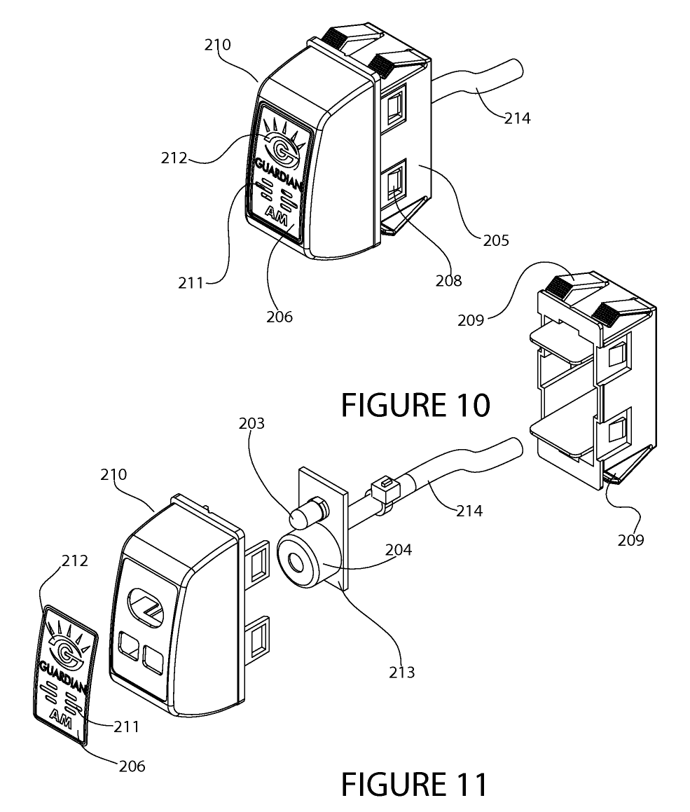

FIGS. 10 and 11 conceptually illustrate an embodiment of a dash module 7 and components thereof for a driver fatigue detection system in accordance with principles of the invention. The exemplary dash module includes a housing 205 with catches 208 for snap-fit attachment of a cover 210 with a faceplate 206. The housing 205 contains a loudspeaker (or buzzer) 204 and a light source (e.g., bi-color LED) 203. Mounting tabs 209 releasably secure the module 7 in a compatible socket. The light source 203 and loudspeaker 204 may be mounted to a base 213 such as a printed circuit board. Extending from the base is a cable or wire harness 214 containing wires for activating the loudspeaker (or buzzer) 204 and light source (e.g., bi-color LED) 203.

Advantageously, the exemplary dash module is configured for installation in a standard socket provided on a dashboards. Such sockets commonly accommodate rocker switches, and the like, for controlling components and accessories. After removing a decorative cover to reveal an available socket, the dash module may readily be plugged into the socket. The mounting tabs 208 secure the housing 205 in the socket. Thus, the dash module will mount cleanly in a standard socket of a dashboard and blend in with other controls and instrumentation in an aesthetically pleasing manner. Alternative embodiments include units configured to mount below or atop of the dashboard, as well as on the windshield, headliner, rear-view mirror, or a head-up display.

A head-up display presents visible images without requiring the driver to look away from the windshield. The head-up display may comprise a combiner, projector unit, and a video generation computer. The combiner, which is the surface onto which the images are projected so that the driver can view it, is coated or otherwise configured to reflect light projected onto it from the projector unit while allowing light from the field of view to pass through. A projection unit projects uses an image projection source such as a cathode ray tube, light emitting diode, liquid crystal display, or other projection means to generate images onto the combiner for the driver to view. A computer provides the interface between the projection unit and the systems/data to be displayed. The computer may be integrated with or coupled to the vehicle's electronic control unit and/or microcontroller 100 and include CAN connectivity.

A calibration control 9 provides an input means for user selection of calibration mode. By way of example and not limitation, a push button switch or any other wired or wireless means of user input to the control module 5 may be provided to select calibration mode and then to signal the beginning and end of a calibration run by the vehicle and driver.

A serial data port 10 provides a user interface connection and means of data exchange. By way of example, the port may be an RS232 port or means for an alternative method for data exchange, such as USB, IrDA, WiFi, Bluetooth, Zigbee, etc. This port is a user interface connection. It may be used for user input of certain operating parameters and also for access to a data log of operating events.

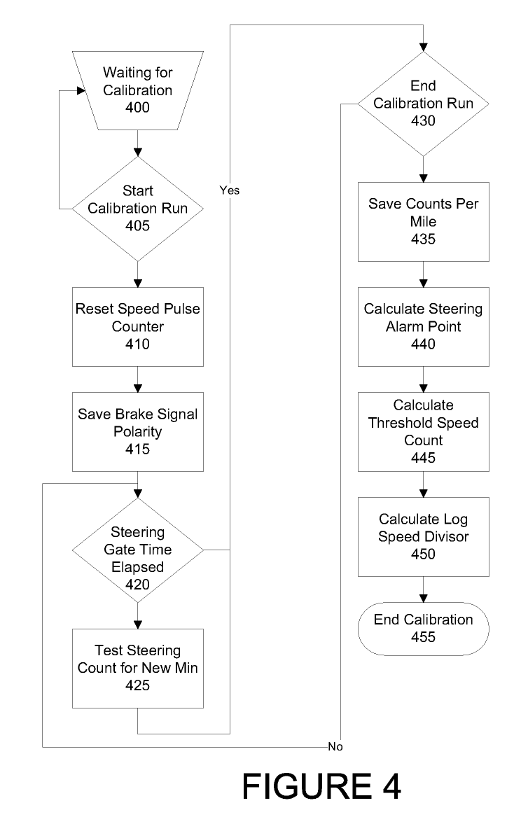

Now that the system hardware has been described, a methodology according to principles of the invention will be described. Referring to FIG. 4, a high level flow chart for an exemplary calibration algorithm is provided. As an initial step, the system waits for an instruction to commence calibration, as in step 400. With reference to step 405, if a commencement instruction is provided, control proceeds to step 410. Otherwise waiting continues in step 405. In an exemplary implementation, a speed/distance sensor 2 positioned next to the drive train of the vehicle measures angular displacement of the drive shaft, thus providing a measure of distance travelled by the vehicle. As different vehicles may have different differential gear ratios and tire diameters, the system resets the speed pulse counter by determining the number of pulses from the speed sensor that correspond to a mile of distance travelled for that particular installation, as in step 410. Similarly, each vehicle may have various steering ratios and varying degrees of mechanical play in the steering linkages. Therefore, to ensure adequate performance, a baseline measurement of steering system activity on a straight road is needed. The installer takes the vehicle to a place with a measured mile that can be traversed with minimal steering. While the speed at which this distance is driven is not important to the calibration procedure, normal driving speeds (e.g., 30 mph to 70 mph) are preferred.

Prior to the calibration run, the installer should have connected a data entry terminal to the control module through the serial data port and set the system operating parameters desired, if they differ from the default values. The calibration process begins when the driver pushes a calibration control button (or otherwise selects calibration) signaling to the control module 5 that the measured mile drive has begun, as in step 405. At that point a counter register is zeroed and begins to accumulate all pulses received from the speed/distance measuring sensor, as in step 410. Also at that time, the brake signal input is tested and that state, high or low, is accepted as the brake not pressed indication, as in step 415. During the remainder of the test drive, the system continually counts the number of pulses from the steering sensor 1 in every steering gate time period, which is typically 3 seconds but may be user selectable. At the end of each period, as in step 420, the new count is compared to the lowest count measured in previous periods, as in step 425. If the new count is lower than the previous minimum count then that new count replaces the minimum value, as in step 425. At the end of the test drive, as in step 430, the register contains the lowest number of steering counts measured in any steering gate time period (e.g., 3-second period) during the entire run.

Advantageously, therefore, a system and method according to principles of the invention determines a baseline measurement of steering system activity (i.e., the lowest number of steering counts measured in any steering gate time period (e.g., 3-second period) during an entire calibration run) for a particular driver and vehicle. Ability to tune the baseline measurement, as described above, ensures that the exemplary system will allow alarm activation when the steering signals fall below the tuned baseline, and minimize false alarms.

As the vehicle passes the next mile marker, the driver presses the calibration control button again, signaling the end of the calibration drive, as in step 430. At this point the system saves the value measured for the number of speed sensor counts per mile, as in step 435. Also, the minimum number of steering sensor counts determined during the calibration is reduced by 10% and saved as the steering alarm threshold, as in step 440. This is the integer value with the mantissa truncated, but never less than one. The system also calculates and saves the number of pulses that will be received per speed gate time period, which is typically 1 second but may be user selectable, when the vehicle is driving at the threshold speed selected for operation, as in step 445. Finally, a value is calculated that when divided into the speed counts in any given speed gate time period, equals the actual speed, as in step 450. This method may be used to calculate the instantaneous speed at the time of an alarm that generates a log entry, so that that speed value can be recorded in the log with the other event data, as in step 450. It is understood that a variable speed gate time could be employed to improve accuracy at lower speeds, i.e. to collect counts for longer periods when the vehicle is travelling at slower speeds.

Advantageously, therefore, a system and method according to principles of the invention may be calibrated for a particular drive train, regardless of the driver and vehicle. Ability to tune or calibrate the speed sensor, as described above, ensures that the exemplary system will accurately log a vehicle speed and avoid alarm activation when the speed is below a threshold.

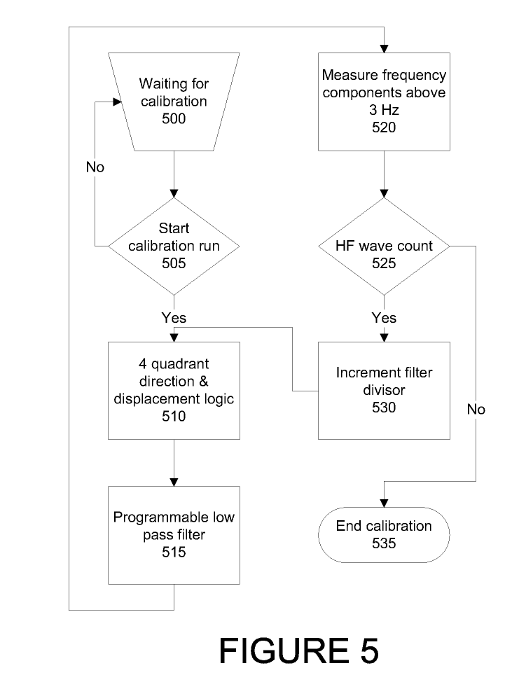

With reference now to FIG. 5, a high level flow chart for a method of calibrating the steering sensor for any given vehicle is conceptually illustrated. Steering systems vary considerably in construction and performance. Of particular interest, some vehicles may have very tight steering systems so that there is very little movement of the steering wheel while driving in a straight line, while others may have much grosser steering control causing the driver to make larger and more frequent corrections. A sensor that has adequate resolution to provide a good signal for the vehicle with fine steering control, may be too sensitive for a vehicle with gross steering control. In the later case, even normal vehicle vibration may generate signals from the steering sensor, thereby producing an unusable signal to noise ratio. Consequently, a calibration methodology is proposed that can measure and compensate for variations in steering systems in target vehicles.

As an initial step, the system waits for an instruction to commence calibration, as in step 500. With reference to step 505, if a commencement instruction is provided, control proceeds to step 510. Otherwise waiting continues in step 505. In step 510, a four quadrant steering direction and displacement logic is applied as a state machine programmed in software to translate changes in the A and B signals supplied by the steering sensor 1 into single counts of clockwise (CW) or counter clockwise (CCW) direction. The sensing element is a motor shaft optical encoder 415 that generates a quadrature output signal comprised of two signals called phase A and B.

Next, in step 515, a programmable low pass filter provides an output described by the following equations:

$$\frac{1}{n} \int f ( x ) d x or \frac{1}{n} {\int }_{l}^{l + ( n - 1 )} f ( x ) d x$$

where l is a starting state number, n is the number of state changes to be integrated, and f(x) is the value of each state change, in either CW or CCW direction, which, by way of example, can be expressed as 1 or −1 respectively.

One way to measure high frequency (e.g., above 3Hz) components in the signal is to set the sample period at the Nyquist frequency of the passband and then look for more than one reversal in phase, i.e. accumulated output from the filter from positive to negative or negative to positive integer values, as in step 520. By way of example, a sample period may be set to 167 ms. The passband (i.e., the range of frequencies or wavelengths that can pass through the filter without being attenuated) may be selected based on observation of actual steering patterns. A determination is made if high frequency wave count exceeds a threshold, as in step 525. For example, if more than one reversal in phase is detected, then it can be concluded that there is energy outside the passband and, concomitantly, that the high frequency wave count exceeds the threshold. In such case, the filter divisor, i.e. the n value in the programmable filter, may be increased for the next set of samples as in step 530 and control passes back to step 510. These steps may be repeated as often as necessary during the calibration drive, until there is never more than one phase change in a sample period. Then the filter divisor (i.e., the n value) is then saved for all future steering measurements, and the steering calibration process ends, as in step 535.

Advantageously, therefore, a system and method according to principles of the invention may be calibrated for a particular steering system, regardless of the driver and vehicle. Ability to tune or calibrate the sensor as described above, ensures that the exemplary steering sensor will work well with a vehicle with fine steering control, a vehicle with gross steering control, and a wide range of vehicles in between.

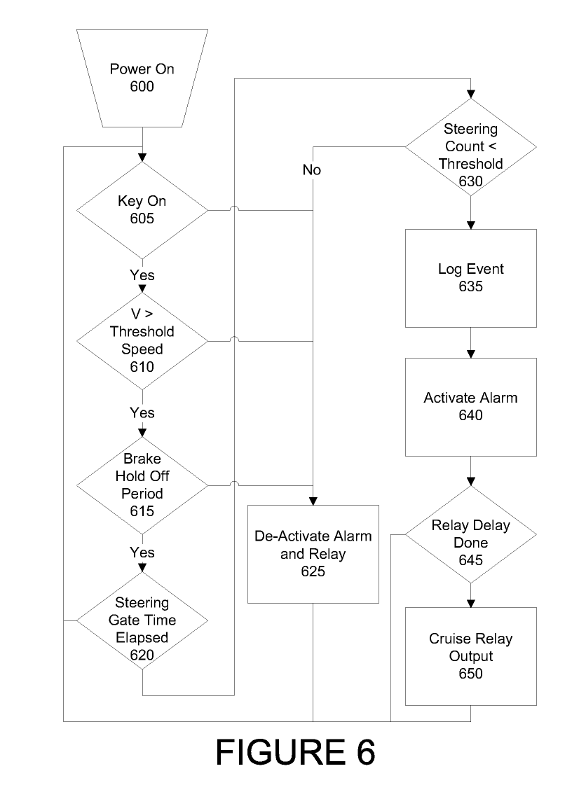

Referring now to FIG. 6, a flow chart for an exemplary low alertness alarm methodology according to principles is provided. The system requires power to operate, as in step 600. If the key is off, as in step 605, or the speed is below a threshold (e.g., a relatively low speed such as 1 to 25 mph) as in step 610, or the brake has been applied recently, as in step 615, then the alarm output is disabled, as in step 625. If the inverse is true and the steering gate time has elapsed, as in step 620, then the number of integer counts from the steering sensor filter is tested to see if it is above the threshold determined during the calibration run, as in step 630. If this count is low, then the event is logged, as in step 635, and the audible alarm is activated, as in step 640. At the same time a relay delay timer is started, as in step 645, so that if the alarm state persists for a preset period of time, then the relay is activated to disable the cruise control, as in step 650.

Advantageously, therefore, a system and method according to principles of the invention accounts for driving conditions that may otherwise inevitably lead to a false alarm. Such conditions include very low speed travel, where steering corrections may be unnecessary. Another such driving condition includes braking, or, more particularly, braking hold off time. During and shortly after braking, the driver is presumed to be attentive.

The step 640 of alarm activation may itself entail several steps. For example, the audible and visible alarms in the dash module 210 may be activated and/or an audible alarm using the speaker 6 in the metal box of the control module 5 may be activated. The activation sequence may be gradual and proceed only so long as a driver steering response is not detected. For example, in the event of alarm activation, the dash module may initially emit an audible and/or visible alarm. Thus, for example, the LED 203 of the exemplary dash module 210 may steadily or intermittently emit visible light and the buzzer or speaker 204 may emit an audible sound. If an appropriate driver steering response is still not detected after a determined period of time, the speaker 6 in the box may be activated. The speaker 6 is a tamper-resistant alarm, which may be substantially louder than the alarm in the dash module, to effectively serve as a safety backup or supplementary audible alarm. Furthermore, after the alarm(s) have been activated, the cruise control will be disabled if the alarm state persists for a preset period of time.

Advantageously, therefore, a system and method according to principles of the invention provides a graduated alarm sequence. A driver is provided ample opportunity to make detectible steering adjustments to avoid progression of the alarm sequence and eventual disabling of cruise control. Thus, driver tranquility is minimally compromised at first. The more intrusive supplementary audible alarm and cruise control disabling are delayed to give a driver opportunity to take remedial action. Only if the driver fails to respond after initiation of the alarm sequence will the alarm sequence continue to progress.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A driver inattention detection system comprising:
a rotary encoder operably associated with a steering column of a vehicle, said rotary encoder being configured to produce steering signals representing at least one of the magnitude and direction of rotation of the steering column;
a control module operably coupled to the rotary encoder and configured to receive said steering signals, determine a steering count and determine if a driver inattention condition exists, said driver inattention condition comprising a steering count below a determined minimum threshold steering count;
a first alarm module operably coupled to said control module, said first alarm module being configured to generate an alarm output perceptible to the driver upon receiving an alarm activation signal;
wherein said control module is configured to generate and communicate a first alarm activation signal to said first alarm module if the control module determines that a driver inattention condition exists.

2. A driver inattention detection system as in claim 1, wherein the rotary encoder comprises a rotatable drive shaft and a drive wheel concentrically coupled to the rotatable shaft, said drive wheel having a peripheral edge, said peripheral edge frictionally engaging the steering column, wherein rotation of the steering column causes said drive wheel to rotate, which causes said rotatable drive shaft to rotate.

3. A driver inattention detection system as in claim 2, further comprising a frictional band configured to surround a portion of the steering column, said peripheral edge of said drive wheel frictionally engaging said frictional band, and said frictional band being further configured to transmit torque from the steering column to the drive wheel.

4. A driver inattention detection system as in claim 3, further comprising a mounting bracket pivotally coupled to the rotary encoder and configured for attachment to a support structure adjacent to the steering column.

5. A driver inattention detection system as in claim 4, further comprising a biasing means configured to urge the rotary encoder with the drive wheel towards the steering column.

6. A driver inattention detection system as in claim 5, said biasing means being configured to maintain traction between the peripheral edge of the drive wheel and the steering column.

7. A driver inattention detection system as in claim 6, said peripheral edge of the drive wheel being frictionally enhanced.

8. A driver inattention detection system as in claim 7, said frictional band being a resilient elastomeric band.

9. A driver inattention detection system as in claim 1, further comprising means for determining speed of the vehicle communicatively coupled to the control module;
said driver inattention condition further comprising a vehicle speed above a minimum threshold speed.

10. A driver inattention detection system as in claim 1, further comprising
means for determining brake activation communicatively coupled to the control module;
said driver inattention condition further comprising the absence of brake activation for a determined time period.

11. A driver inattention detection system as in claim 1, said rotary encoder being an optical rotary encoder.

12. A driver inattention detection system as in claim 1, said first alarm module comprising an alarm unit configured to plug into a socket in a dashboard.

13. A driver inattention detection system as in claim 1, said first alarm module comprising an alarm unit from the group consisting of
a unit configured to plug into a socket in a dashboard, and including a light emitting element and a sound emitting element;
a unit configured to attach to a dashboard, and including a light emitting element and a sound emitting element;
a unit configured to attach to a windshield, and including a light emitting element and a sound emitting element;
a unit configured to attach to a headliner, and including a light emitting element and a sound emitting element;
a unit configured to attach to a rearview mirror, and including a light emitting element and a sound emitting element; and
a head-up display and a sound emitting element.

14. A driver inattention detection system as in claim 1, further comprising a second alarm module separate from the first alarm module, and said control module being configured to generate and communicate a second alarm activation signal to said second alarm module if the control module determines that a driver inattention condition persists a determined amount of time after a first alarm activation signal is generated and communicated to said first alarm module.

15. A driver inattention detection system as in claim 1, further comprising a calibration mode selection switch communicatively coupled to said control module, and an adjustable low pass filter configured to receive steering signals, said control module being configured to operate in calibration mode when said calibration mode selection switch is activated, said calibration mode adjusting the low pass filter until a high frequency wave count does not exceed a threshold and the steering signals received by the control module through the filter represent the magnitude and direction of rotation of the steering column.

16. A method for driver inattention detection comprising:
using an adjustable low pass filter, calibrating a rotary encoder operably associated with a steering column of a vehicle, said calibrated rotary encoder producing steering signals representing the magnitude and direction of rotation of the steering column;
determining a minimum threshold steering count in a determined time period during a calibration run;
determining an active steering count representing steering system activity during driving;
determining if a driver inattention condition exists, said driver inattention condition comprising an active steering count below the determined minimum threshold steering count; and
activating a first alarm perceptible to a driver upon determining that a driver inattention condition exists.

17. A method for driver inattention detection as in step 16, wherein said driver inattention condition comprises an active steering count below the determined minimum threshold steering count and the absence of braking activity over a determined period of time preceding the step of determining if a driver inattention condition exists.

18. A method for driver inattention detection as in step 16, wherein said driver inattention condition comprises an active steering count below the determined minimum threshold steering count while the vehicle travels at a minimum threshold speed determined during a period of time preceding the step of determining if a driver inattention condition exists.

19. A method for driver inattention detection as in step 16, further comprising activating a second alarm perceptible to a driver upon determining that a driver inattention condition persists for a determined time after activating the first alarm.

20. A method for driver inattention detection as in step 19, further comprising disabling a cruise control module upon determining that a driver inattention condition persists for a determined time after activating the second alarm.
